(19) United States
(12) Patent Application Publication
(10) Pub. No.: US 2019/0197988 A1
(43) Pub. Date: Jun. 27, 2019

(54) DISPLAY MODE CONVERSION METHOD APPLIED TO DISPLAY DRIVING CIRCUIT

(71) Applicant: Raydium Semiconductor Corporation, Hsinchu (TW)

(72) Inventors: Chien-Lin HUANG, Hsinchu City (TW); Zi-Hao HSIUNG, Hsinchu City (TW)

(21) Appl. No.: 16/231,433

(22) Filed: Dec. 22, 2018

Related U.S. Application Data
(60) Provisional application No. 62/610,306, filed on Dec. 26, 2017.

(51) Int. Cl. G09G 5/10; G09G 3/34

(52) U.S. Cl. CPC G09G 5/10; G09G 3/3406; G09G 2320/0276; G09G 2320/0673; G09G 2320/0626

(57) ABSTRACT

A display mode conversion method applied to a display driving circuit is disclosed. The display driving circuit is switched between a first display mode and a second display mode. The display mode conversion method includes steps of: (a) finding a ratio setting when the second display mode displays a default brightness according to the default brightness under the first display mode; (b) when receiving a first mode switching command under the first display mode, gradually adjusting to the default brightness; (c) switching to the second display mode and maintaining displaying the default brightness according to the ratio setting; and (d) under the second display mode, gradually adjusting from the default brightness to a target brightness.

### BACKGROUND OF THE INVENTION

### 1. Field of the Invention

The invention relates to a display driving circuit; in particular, to a display mode conversion method applied to a display driving circuit.

### 2. Description of the Prior Art

In general, when the display driving circuit in the conventional display device switches between different display modes, the display driving circuit uses different gamma curves to achieve different degrees of display brightness.

For example, if the display driving circuit is operated in the normal mode, when the display driving circuit receives the display mode switching command, the display driving circuit will be switched from the normal mode to the high brightness mode (HBM) and load the gamma curve corresponding to the high brightness mode.

Similarly, assuming that the display driving circuit is originally operated in the high brightness mode, when the display driving circuit receives the display mode switching command, the display driving circuit will be switched from the high brightness mode to the normal mode and load the gamma curve corresponding to the normal mode.

However, at the moment of switching between the normal mode and the high brightness mode, changing different gamma curves will cause the brightness of the frame displayed by the display device to suddenly change, and the progressive change cannot be presented, which seriously affects the visual perception when the user is watching.

### SUMMARY OF THE INVENTION

Therefore, the invention provides a display mode conversion method applied to a display driving circuit to solve the above-mentioned problems of the prior arts.

A preferred embodiment of the invention is a display mode conversion method. In this embodiment, the display mode conversion method is applied to a display driving circuit. The display driving circuit is switched between a first display mode and a second display mode. The display mode conversion method includes steps of: (a) finding a ratio setting when the second display mode displays a default brightness according to the default brightness under the first display mode; (b) when receiving a first mode switching command under the first display mode, gradually adjusting to the default brightness; (c) switching to the second display mode and maintaining displaying the default brightness according to the ratio setting; and (d) under the second display mode, gradually adjusting from the default brightness to a target brightness.

In an embodiment, the display mode conversion method further includes steps of: (e) when receiving a second mode switching command under the second display mode, gradually adjusting to the default brightness according to the ratio setting; (f) switching to the first display mode and maintaining displaying the default brightness; and (g) under the first display mode, gradually adjusting from the default brightness to another target brightness.

In an embodiment, the first display mode is a normal mode and the second display mode is a high brightness mode.

In an embodiment, the first display mode is a high brightness mode and the second display mode is a normal mode.

In an embodiment, the first display mode corresponds to a first gamma curve and the second display mode corresponds to a second gamma curve; the step (a) finding a corresponding first gamma value on the first gamma curve and a corresponding second gamma value on the second gamma curve according to the default brightness to obtain the ratio setting.

In an embodiment, the step (b) gradually adjusts to the first gamma value on the first gamma curve according to the first mode switching command to gradually adjust to the default brightness.

In an embodiment, the step (c) loads the second gamma curve and maintains the second gamma curve at the second gamma value according to the ratio setting to maintain displaying the default brightness.

In an embodiment, the step (d) gradually adjusts the second gamma curve from the second gamma value to the target gamma value corresponding to the target brightness to gradually adjust from the default brightness to the target brightness.

In an embodiment, the step (e) gradually adjusts to the ratio setting second gamma value on the second gamma curve according to the second mode switching command to gradually adjust to the default brightness.

In an embodiment, the step (0 loads the first gamma curve and maintains the first gamma curve at the first gamma value to maintain displaying the default brightness.

In an embodiment, the step (g) gradually adjusts the first gamma curve from the first gamma value to another target gamma value corresponding to the another target brightness to gradually adjust from the default brightness to the another target brightness.

Compared to the prior art, the display mode conversion method applied to the display driving circuit of the invention finds the proportional conversion point of the same brightness in the gamma values of different brightness modes and combined with the dimming method, so that when the display device switches between different brightness modes, the frame displayed by the display device does not have a flickering phenomenon in which the brightness suddenly changes, and the effect of gradually changing brightness can be provided to enhance the visual experience of the user.

The advantage and spirit of the invention may be understood by the following detailed descriptions together with the appended drawings.

### BRIEF DESCRIPTION OF THE APPENDED DRAWINGS

FIG. 1 illustrates a flowchart of the display mode conversion method in an embodiment of the invention.

FIG. 2˜FIG. 8 illustrate schematic diagrams of the steps S10˜S16 in an embodiment respectively.

### DETAILED DESCRIPTION OF THE INVENTION

A preferred embodiment of the invention is a display mode conversion method. In this embodiment, the display mode conversion method is applied to a display driving circuit in a display device. The display driving circuit can switch between a first display mode and a second display mode, so that the display device can display frames under the first display mode and the second display mode respectively.

In fact, the first display mode and the second display mode can provide different brightness. For example, the first display mode is a normal mode and the second display mode is a high brightness mode, or the first display mode is the high brightness mode and the second display mode is the normal mode, but not limited to this.

It should be mentioned that although the first display mode and the second display mode are taken as an example in this embodiment, the display mode conversion method of the invention can be also applied to the conversions between more different display modes.

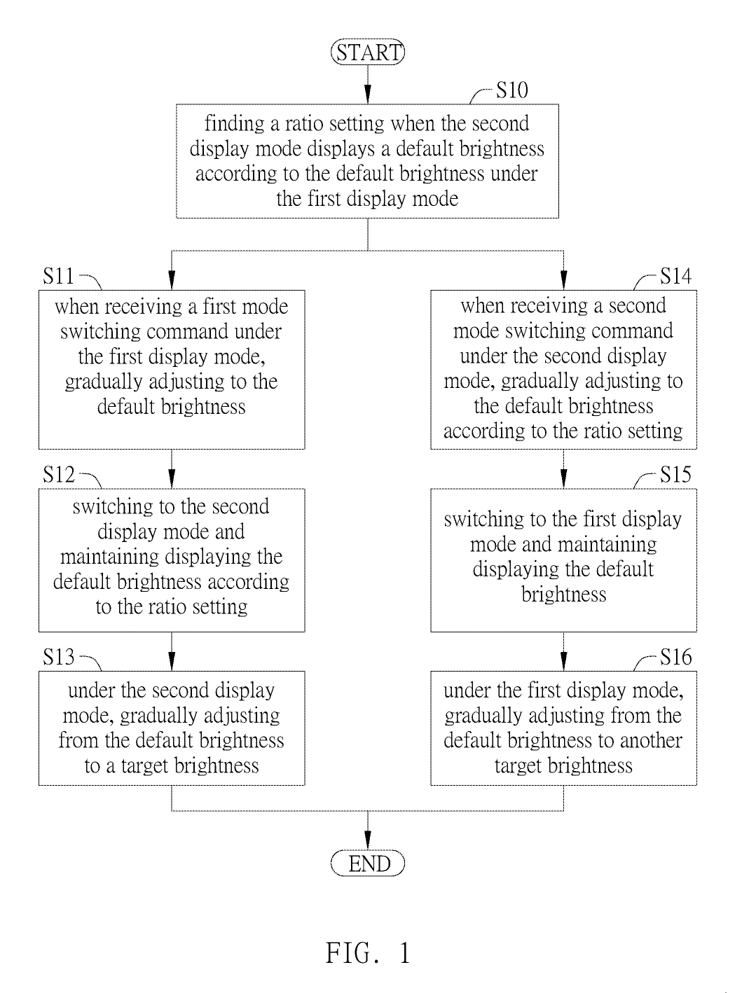

Please refer to FIG. 1. FIG. 1 illustrates a flowchart of the display mode conversion method in this embodiment. As shown in FIG. 1, the display mode conversion method can include the following steps S10˜S16:

Step S10: finding a ratio setting when the second display mode displays a default brightness according to the default brightness under the first display mode;

Step S11: when receiving a first mode switching command under the first display mode, gradually adjusting to the default brightness;

Step S12: switching to the second display mode and maintaining displaying the default brightness according to the ratio setting;

Step S13: under the second display mode, gradually adjusting from the default brightness to a target brightness;

Step S14: when receiving a second mode switching command under the second display mode, gradually adjusting to the default brightness according to the ratio setting;

Step S15: switching to the first display mode and maintaining displaying the default brightness; and

Step S16: under the first display mode, gradually adjusting from the default brightness to another target brightness.

It should be mentioned that in the above steps S10˜S16, the step S10 belongs to the pre-measurement setting stage before the display mode switching; the steps S11˜S13 belong to the use scenario of switching from the first display mode to the second display mode; the steps S14˜S16 belong to the use scenario of switching from the second display mode to the first display mode.

Next, the above steps S10 to S16 will be described in detail.

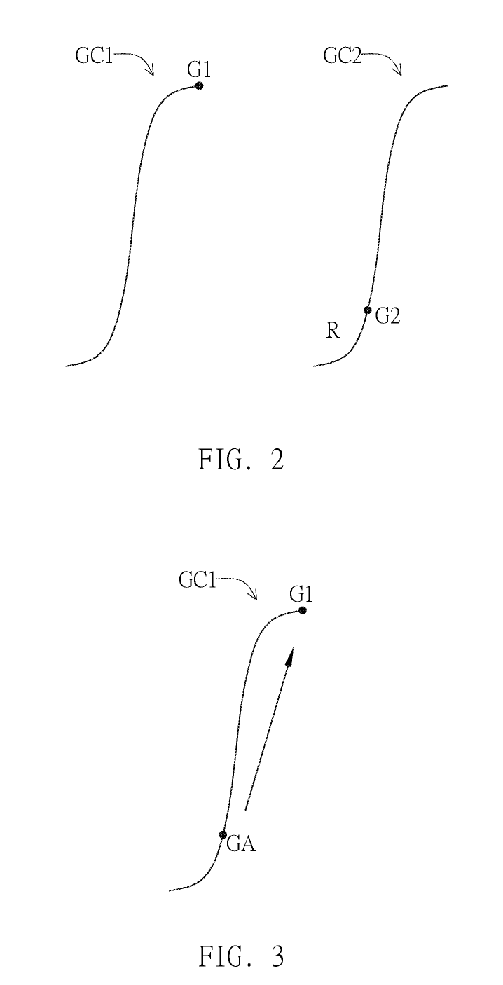

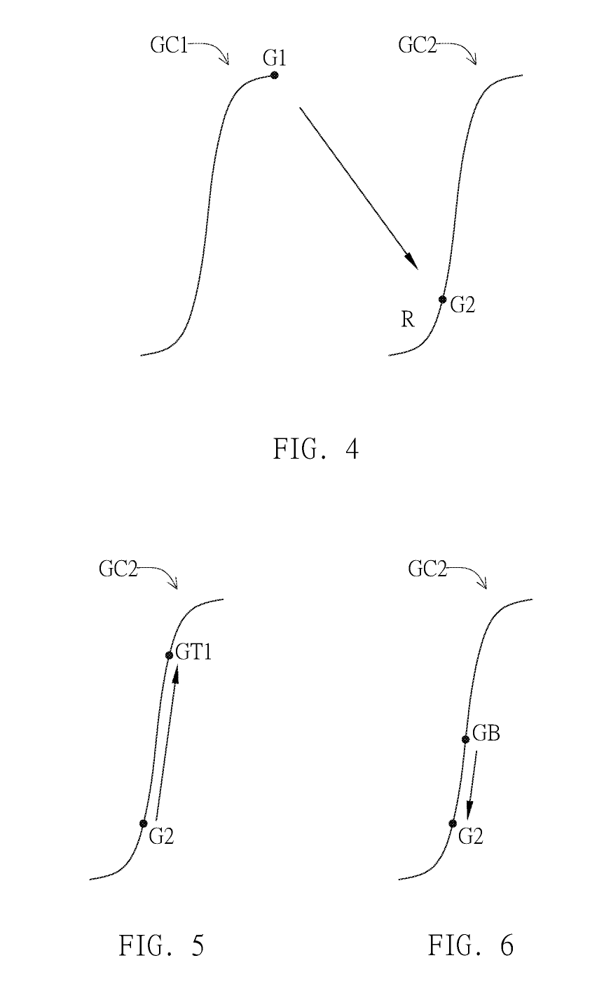

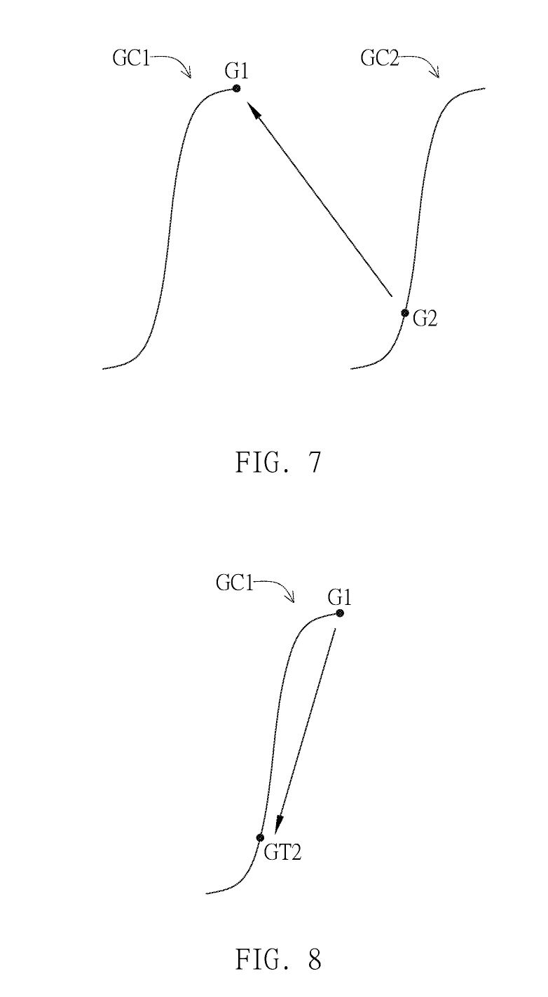

In the pre-measurement setting stage before the display mode switching starts, as shown in FIG. 2, it is assumed that the first display mode corresponds to the first gamma curve GC1 and the second display mode corresponds to the second gamma curve GC2. The step S10 can find the corresponding first gamma value G1 on the first gamma curve GC1 and the corresponding second gamma value G2 on the second gamma curve GC2 according to the default brightness to obtain the ratio setting R.

For example, it is assumed that the first display mode is the normal mode and the second display mode is the high brightness mode, if the default brightness is the maximum brightness in the normal mode, the step S10 can find the second gamma value G2 of the second gamma curve GC2 when displaying the default brightness (e.g., the maximum brightness in the normal mode) under the high brightness mode to obtain a ratio setting R under the high brightness mode. In fact, the ratio setting R can include a proportional relationship of the second gamma value G2 in all gamma values of the second gamma curve GC2, but not limited to this.

Next, the use scenario of switching from the first display mode to the second display mode and the use scenario of switching from the second display mode to the first display mode will be introduced respectively as follows.

In the use scenario of switching from the first display mode to the second display mode, when the display driving circuit receives the first mode switching command, it represents switching from the normal mode to the high brightness mode, as shown in FIG. 3, the step S11 can gradually adjust from the original gamma value GA to the first gamma value G1 on the first gamma curve GC1 according to the first mode switching command, so that the brightness displayed by the display device can be gradually adjusted to a default brightness (e.g., the maximum brightness in the normal mode), so that this dimming method can provide the effect of gradually changing brightness.

Next, as shown in FIG. 4, the step S12 can load the second gamma curve GC2 and maintain the second gamma curve GC2 at the second gamma value G2 according to the ratio setting R under the high brightness mode obtained in the step S10 to maintain displaying the default brightness (e.g., the maximum brightness in the normal mode).

Thereby, in the process of switching from the normal mode to the high brightness mode in the invention, it will convert from the first gamma curve GC1 to the second gamma curve GC2, but at the moment when the different brightness display mode is switched, the brightness displayed by the display device is maintained at the default brightness (e.g., the maximum brightness in the normal mode), so that the user does not have a visual feeling of sudden change in brightness when viewing, and the disadvantages of the prior art can be effectively improved.

In the high brightness mode, as shown in FIG. 5, the step S13 can gradually adjust the second gamma curve GC2 from the second gamma value G2 to a target gamma value GT1 corresponding to the target brightness, so that the brightness displayed by the display device can be gradually adjusted from the default brightness (e.g., the maximum brightness in the normal mode) to the target brightness; therefore, this dimming method can provide the effect of gradually changing brightness.

In the use scenario of switching from the second display mode to the first display mode, when the display driving circuit receives the second mode switching command, it represents switching from the high brightness mode to the normal mode, as shown in FIG. 6, the step S14 can gradually adjust from the original gamma value GB to the second gamma value G2 on the second gamma curve GC2 according to the ratio setting R under the high brightness mode obtained in the step S10, so that the brightness displayed by the display device can be gradually adjusted to the default brightness (e.g., the maximum brightness in the normal mode); therefore, this dimming method can provide the effect of gradually changing brightness.

Next, as shown in FIG. 7, the step S15 can load the first gamma curve GC1 and maintain the first gamma curve GC1 at the first gamma value G1 to maintain displaying the default brightness (e.g., the maximum brightness in the normal mode).

Thereby, in the process of switching from the high brightness mode to the normal mode, it will convert from the second gamma curve GC2 to the first gamma curve GC1, but at the moment when the different brightness display mode is switched, the brightness displayed by the display device is maintained at the default brightness (e.g., the maximum brightness in the normal mode), so that the user does not have a visual feeling of sudden change in brightness when viewing, and the disadvantages of the prior art can be effectively improved.

In the normal mode, as shown in FIG. 8, the step S16 can gradually adjust the first gamma curve GC1 from the first gamma value G1 to the target gamma value GT2 corresponding to the target brightness, so that the brightness displayed by the display device can be gradually adjusted from the default brightness (e.g., the maximum brightness in the normal mode) to the target brightness; therefore, this dimming method can provide the effect of gradually changing brightness.

Compared to the prior art, the display mode conversion method applied to the display driving circuit of the invention finds the proportional conversion point of the same brightness in the gamma values of different brightness modes and combined with the dimming method, so that when the display device switches between different brightness modes, the frame displayed by the display device does not have a flickering phenomenon in which the brightness suddenly changes, and the effect of gradually changing brightness can be provided to enhance the visual experience of the user.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display mode conversion method applied to a display driving circuit, the display driving circuit being switched between a first display mode and a second display mode, the display mode conversion method comprising steps of:
(a) finding a ratio setting when the second display mode displays a default brightness according to the default brightness under the first display mode;
(b) when receiving a first mode switching command under the first display mode, gradually adjusting to the default brightness;
(c) switching to the second display mode and maintaining displaying the default brightness according to the ratio setting; and
(d) under the second display mode, gradually adjusting from the default brightness to a target brightness.

2. The display mode conversion method of claim 1, further comprising steps of:
(e) when receiving a second mode switching command under the second display mode, gradually adjusting to the default brightness according to the ratio setting;
(f) switching to the first display mode and maintaining displaying the default brightness; and
(g) under the first display mode, gradually adjusting from the default brightness to another target brightness.

3. The display mode conversion method of claim 1, wherein the first display mode is a normal mode and the second display mode is a high brightness mode.

4. The display mode conversion method of claim 1, wherein the first display mode is a high brightness mode and the second display mode is a normal mode.

5. The display mode conversion method of claim 1, wherein the first display mode corresponds to a first gamma curve and the second display mode corresponds to a second gamma curve; the step (a) finding a corresponding first gamma value on the first gamma curve and a corresponding second gamma value on the second gamma curve according to the default brightness to obtain the ratio setting.

6. The display mode conversion method of claim 5, wherein the step (b) gradually adjusts to the first gamma value on the first gamma curve according to the first mode switching command to gradually adjust to the default brightness.

7. The display mode conversion method of claim 6, wherein the step (c) loads the second gamma curve and maintains the second gamma curve at the second gamma value according to the ratio setting to maintain displaying the default brightness.

8. The display mode conversion method of claim 7, wherein the step (c) loads the second gamma curve and maintains the second gamma curve at the second gamma value according to the ratio setting to maintain displaying the default brightness.

9. The display mode conversion method of claim 2, wherein the step (e) gradually adjusts to the ratio setting second gamma value on the second gamma curve according to the second mode switching command to gradually adjust to the default brightness.

10. The display mode conversion method of claim 9, wherein the step (f) loads the first gamma curve and maintains the first gamma curve at the first gamma value to maintain displaying the default brightness.

11. The display mode conversion method of claim 10, wherein the step (g) gradually adjusts the first gamma curve from the first gamma value to another target gamma value corresponding to the another target brightness to gradually adjust from the default brightness to the another target brightness.
